(19) United States
(12) Patent Application Publication
(10) Pub. No.: US 2014/0359645 A1
(43) Pub. Date: Dec. 4, 2014

(54) ISSUING CREDIT ACCORDING TO REMAINING PURCHASE INFORMATION OF ON-DEMAND VIDEO SERVICE

(71) Applicant: Seung-hak Kim, Seoul (KR)

(72) Inventor: Seung-hak Kim, Seoul (KR)

(73) Assignee: CASTIS CO., LTD., Seoul (KR)

(21) Appl. No.: 14/370,798

(22) PCT Filed: Jan. 9, 2012
(86) PCT No.: PCT/KR2012/000198

§ 371 Date: Aug. 8, 2014

(30) Foreign Application Priority Data
Jan. 5, 2012 (KP) 10-2012-0001557

(51) Int. Cl. H04N 21/2543

(52) U.S. Cl. CPC H04N 21/2543; G06Q 40/025
USPC 725/5

(57) ABSTRACT

The present invention relates to a method of issuing credit to a subscriber by a managing device in an on-demand video system. The method includes receiving a request for credit information on a subscriber from a receiver, determining exchangeable credit based on the remaining purchase information on the subscriber in response to the request for credit information, transmitting information on the determined credit to the receiver, receiving an exchange request including selective information on at least some pieces of the determined credit for the receiver, and issuing credit corresponding to the selective information, to the subscriber.

### TECHNICAL FIELD

The present invention relates to issuing credit according to remaining purchase information of on-demand video service.

### BACKGROUND ART

Video-on-demand (VOD) services are multimedia services which provide stored contents with users according to their requests. Early VOD services provided only videos. However, recent VOD services provide videos together with additional services such as advertisements, coupons, etc.

Prior arts that provide coupons etc., as additional services for VOD services, are as follows. Korean Patent Application Publication No. 10-2002-0014485 discloses an advertising system in which users participate in advertisement broadcastings including coupon information and a company of repayment of the coupons distributes a portion of advertisement profits to advertisers, store-owners and viewers. In addition, PCT/US2009/066829 discloses methods and systems enable receiver devices to receive electronic coupons from mobile TV broadcast service providers, using digital signature. Further, Korean Patent Application Publication No. 10-2006-0128549 discloses a method for providing coupons by using digital multimedia transmission system.

As mentioned above, additional services such as advertisements in VOD services, coupon offerings, etc. are provided by providing or distributing advertisements or coupons via VOD networks, which are generally irrespective of main services that provide multimedia contents.

### DISCLOSURE

### Technical Problem

The techniques disclosed in the present specification have been developed so that a subscriber may provide other subscriber who purchased VOD contents with a right to enjoy additional services based on purchase information. In particular, the present invention provides a subscriber who paid expenses for purchasing contents in VOD services, with a method for purchasing other additional services when remaining purchase information is present. The present invention is to provide a method and a device for exchanging purchase information for credit to other services, where the purchase information is remaining purchase information that is left without consumption out of the services purchased in VOD services by a subscriber.

### Technical Solution

As one embodiment, there is disclosed a method for issuing credit for a subscriber in an on-demand video system. The method comprises receiving a request for credit information on a subscriber from a receiver; determining exchangeable credit based on the remaining purchase information on the subscriber in response to the request for credit information; transmitting information on the determined credit to the receiver; receiving an exchange request including selective information on at least a part of the determined credit from the receiver; and issuing credit corresponding to the selective information, to the subscriber.

The above-mentioned embodiment and other embodiments of the present invention have any one of the following characteristics.

The credit may be information on time of watching the on-demand video, number of watching the on-demand video, mileage, point or coupon.

In addition, the step of issuing may comprise allocating the credit corresponding to the selective information to the subscriber; and decreasing the remaining purchase information according to an amount of the selective information. Moreover, the method of the present invention may further comprise receiving available credit information from a credit issuer, wherein the exchangeable credit is determined from the available credit. Furthermore, the method of the present invention may further comprise transmitting the allocated credit information to the subscriber.

Additionally, the remaining purchase information of the subscriber may be obtained from a right management server, based on identification information of the subscriber. The method of the present invention may further comprise requesting to the right management server for decreasing the remaining purchase information of the subscriber, based on an amount of the selective information.

Moreover, the method of the present invention may further comprise notifying the receiver of the issued credit.

In addition, the method of the present invention may further comprise notifying the subscriber of the issued credit. In this case, the step of notifying may be that the issued credit is notified to the subscriber by transmitting information on the issued credit to a mobile terminal, an e-mail address or an individual data storage of the subscriber.

Further, the subscriber is identified by subscriber identification information including at least one information selected from the group consisting of a user ID, a telephone number, a receiver identification number, a resident registration number, a social security number, an account number, a personal identification number (PIN), or a medium access control (MAC) address of a receiver.

In another embodiment, there is disclosed a device for issuing credit in an on-demand video system. The device comprises a storage part which stores a remaining purchase information and an available credit of a subscriber; a communication part which communicates with a receiver through a management channel; and a control part which issues credit for the subscriber in cooperation with the storage part and the communication part, wherein the communication part receives a request for credit information from the receiver, transmits information on exchangeable credit information to the receiver, and receives an exchange request including selective information on at least a part of the exchangeable credit, and wherein the control part determines the exchangeable credit based on the remaining purchase information on the subscriber in response to the request for credit information, and issues credit corresponding to the selective information, to the subscriber.

The above-mentioned another embodiment and other embodiments of the present invention have any one of the following characteristics.

The credit may be information on time of watching the on-demand video, number of watching the on-demand video, mileage, point or coupon.

In addition, the communication part may communicate with a credit issuer which provides the credit information, and the storage part may store the available credit received from the credit issuer. In this case, the communication part may transmit the credit information issued for the subscriber to the credit issuer.

Further, the control part may allocate the credit corresponding to the selective information to the subscriber, and decrease information out of the remaining purchase information, to an extent that corresponds to an amount of the selective information. In the meantime, the communication part may communicate with the right management server which provides purchase information of the subscriber, and the storage part may store the remaining purchase information of the subscriber, received from the right management server. Moreover, the communication part may request the right management server to decrease information out of the remaining purchase information, to an extent that corresponds to an amount of the selective information.

In addition, the device may further comprise a notification part which notifies the subscriber of information on the issued credit, and the notification part may transmit information on the issued credit to a mobile terminal, an e-mail address or an individual data storage of the subscriber. Furthermore, the communication part may notify the terminal of information on the issued credit.

In yet another embodiment, there is disclosed a method for obtaining credit in an on-demand video system based on a remaining purchase information. The method may comprise transmitting a request for credit information of a subscriber to a management device; receiving a exchangeable credit information of the subscriber; displaying the exchangeable credit information on a display part; receiving input signals to select at least a part from the exchangeable credit information; transmitting an exchange request including the information selected by the input signals; and receiving the issued credit information based on the remaining purchase information in response to the exchange request.

In another embodiment, there is disclosed a device for receiving video which provides credit in an on-demand video system. The device may comprise a communication part which receives a exchangeable credit information of a subscriber from a management device and transmits an exchange request to the management device; a display part which displays the exchangeable credit information; an input part which inputs input signals selecting at least a part of the exchangeable credit information; a control part which obtains issued credit for the subscriber in cooperation with the communication part, the display part and the input part, wherein the exchange request may include selective credit information according to the input signals, and wherein the issued credit may be issued in response to the exchange request, based on remaining purchase information of the subscriber.

### Advantageous Effects

The on-demand video system according to embodiments disclosed in the specification allows for exchanging the remaining time or chances of watching the on-demand video with credit.

Since the on-demand video system according to embodiments disclosed in the specification allows for exchanging non-usable payment with other credit, it may be avoided that remaining payment cannot be consumed.

### BRIEF DESCRIPTION OF THE DRAWINGS

FIG. 1 is a block diagram of an exemplary embodiment of the on-demand video system disclosed in the present specification.

FIG. 2 is a block diagram of an exemplary embodiment of the receiver disclosed in the present specification.

FIG. 3 shows an exemplary VOD system which issues credit based on remaining purchase information.

FIG. 4 illustrates an exemplary method for issuing credit based on purchase information.

FIG. 5 shows an exemplary screen on which the receiver displays the remaining purchase information and exchangeable credit.

FIG. 6 is a flow chart that describes in detail the issuing procedure of credit shown in FIG. 4.

FIG. 7 is a flow chart illustrating an embodiment of notifying the information of the issued credit to a subscriber.

FIG. 8 is a flow chart illustrating the procedure of exchanging all of the remaining purchase information with credit.

### BEST MODE FOR CARRYING OUT THE INVENTION

The techniques disclosed in the present specification are applicable to video-on-demand (on-demand video) services. However, the techniques disclosed in the present specification are not limited thereto. The technical idea of the present invention may be applicable to video/audio contents distribution devices/methods, methods or devices for broadcasting, methods and devices for contents management, etc.

The technical term for the purpose of describing particular embodiments only be used, is not intended to limit the present invention should be noted. In addition, the technical terms used herein are defined as used herein unless a different meaning in particular, the present invention is not skilled in the art generally understood by those should be interpreted to mean, excessively comprehensive interpreted as meaning, or excessively reduced not to be interpreted as meaning. Further, the technical terms used herein have the spirit of the invention does not accurately represent the days when the wrong technical terms, this invention belongs skilled in the art can understand the technical term for self correctly understood to be replaced by will. Further, the general terms used in the present invention are defined in accordance with a pre-, or mixed should be interpreted according to the context, an excessively reduced not to be interpreted as meaning.

Further, as used herein, the singular a clearly different meaning in the context of the expression of the plural, unless expressed and the like. In the present application, “consists of”, or “comprises” is intended to set forth such as various components, or various steps should not be construed to necessarily include all, and that some of the components or some of the steps are may not be included, or more additional components or steps that can be interpreted to be included.

Further, as used herein for the component suffixes “module” and “part” is herein considered only the easiness of writing as being granted or mixed, in itself a distinct role or is not meaningful.

Further, as used herein the first and second containing a term, such as ordinal can be used in describing various elements, but the above elements by the above terms should not be limited. The above terms are one element from the other used only to distinguish. For example, in the present invention without departing from the scope of the first component to the second component may be named similarly, the second component to the first component also can be named.

Hereinafter, with reference to the accompanying drawings, preferred embodiments according to the present invention will be described in detail, but the same or similar reference numerals, regardless of the components of the same reference numerals and thus the duplicate description will be omitted.

Further, the following description is a detailed description of known technique of the present invention may obscure the subject matter if it is determined that a detailed description thereof will be omitted. Further, the accompanying drawings easy to understand the spirit of the invention as intended to allow, in the accompanying drawings is limited by the scope of the invention should not be construed note that.

On-Demand Video System

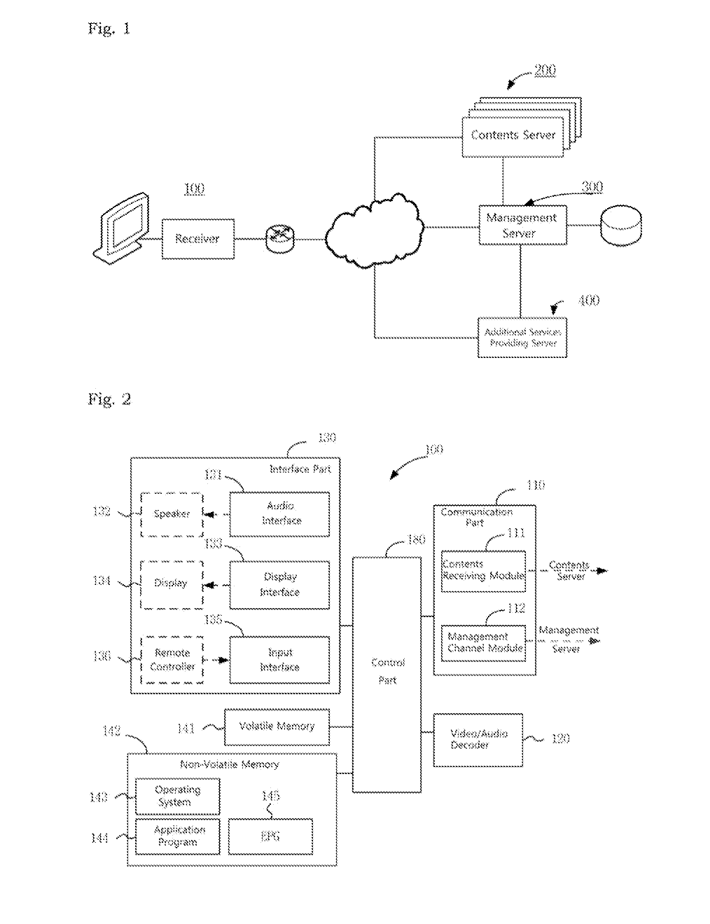

FIG. 1 is a block diagram of an exemplary embodiment of the on-demand video system disclosed in the present specification.

Referring to FIG. 1, the exemplary on-demand video system comprises a receiver (100), a contents server (200), a management device (300) and an additional services providing server (400).

The receiver (100) is a device in which a subscriber consumes video contents. The receiver (100) receives multimedia contents from the contents server (200), consumes the received contents, and communicates with the management device (300).

The receiver (100) may be embodied as various forms of device which receive and consume multimedia contents. For example, the receiver (100) may be embodied as a personal computer, a tablet, a mobile terminal, a TV, a set-top box, etc.

Entities of the on-demand video system are linked through networks. The networks which link the entities are embodied in a variety of ways such as the conventional wired/wireless communication, for example, cable networks including coaxial cables, IP (internet protocol)-based networks including wired data networks, and satellite networks. In addition, the networks include various networks such as access network, backbone network, etc. and may carry out data transmission by using different kinds of protocols.

The contents server (200) distributes contents to the receiver (100). The contents server (200) may be embodied as one or more network servers. In particular, the contents server (200) may comprise one or more network servers and a session management server. The receiver (100) may receive contents from one or more servers which are determined out of one or more contents distribution servers by the session management server. The session management server performs the management function that allocates and modify the resources used for distribution of contents, and may establish and release sessions between the receiver (100) and the contents distribution server. The session management server, when receiving a request for contents transmission from the receiver (100), checks the state of services or resources such as frequency band of the contents distribution servers, determines servers which will participate in distributing contents, based on the state of resources and the distribution policy, transmits information on the determined servers to the receiver (100) and, thereby, enables the receiver (100) to receive multimedia contents from the determined contents distribution server.

The management device (300) controls the receiver (100) and the contents server (300) so as to carry out distribution of contents to subscribers to the on-demand video system, authentication of a subscriber, change of contents channels, management of additional services, etc. The management device (300) may be called as a headend access system (HAS). The management device (300) may provide any required information to application programs which are executing for VOD services in the receiver (100).

In the meantime, the management device (300) manages information such as subscription, withdrawal, etc. of subscribers. In addition, the management device (300) may store information on subscribers in the embedded storage part, or in the right management server (500) which manages information on subscribers. Then, the management device (300) may perform authentication of the subscribers, based on the stored information.

The additional services providing server (400) provides additional services together with VOD services according to control of the management device (300).

In embodiments disclosed in the specification, credit management server which manages credit is disclosed as one example of the additional services providing server (400). The credit management server provides the management device (300) with credit as an exchange for the sake of other service providers, contents providers.

As used herein, the term “credit” refers to a unit that can be exchanged with right allowing for consuming VOD services which have already been purchased by a subscriber. The credit represents a value unit that can be consumed in order to receive other VOD services, other VOD contents, other additional services, products or rights. The credit may be provided by various entities, for example, VOD service providers, additional service provider, contents provider, advertisement providers, etc. The credit may be replaced with the terms, coupon, token, right, etc. Examples disclosed in the specification include time of watching said on-demand videos, number of watching said on-demand videos, mileages, accumulated points, gift cards, coupons, etc.

VOD Receiver

FIG. 2 is a block diagram of an exemplary embodiment of the receiver disclosed in the present specification.

With reference to FIG. 2, the receiver may comprise a communication part (110), a video/audio decoder (120), an interface part (130), a storage part (140) and a control part (180).

The communication part (110) may comprise a contents receiving module (111) which receives multimedia contents from the contents server through networks, and a management channel module (112) which transmits or receives management commands such as purchase, consumption, etc. of multimedia contents from the management device.

The contents receiving module (111) may receive contents by using broadcast protocol. In addition, the contents receiving module (111) may facilitate to distribute IP network-based contents. For example, the contents receiving module (111) may carry out the contents distribution function according to DVB-MHP (digital video broadcasting multimedia home platform), ACAP (advanced common application platform) or OCAP (open cable application platform) standards. The contents receiving module (111) may receive the contents by way of multicast through the IP networks.

The management channel module (112) is a module that transmits/receives management commands through a bandwidth except the bandwidth for contributing contents, or separate communication channels. The management channel module (112) may communicate with the management device (300) by using a channel such as a return-path, etc. on the network. In addition, the management channel module (112) may communicate with the management device (300) via a separate point-to-point method or a unicast method.

The video/audio decoder (120) decompresses the multimedia contents received through the contents receiving module (111) so that the multimedia contents may be identified by frames.

The interface part (130) is a circuit that links to the auxiliary modules attached to the external auxiliary devices or the receiver (100) itself. The interface (130) may include an audio interface (131), a display interface (132) and an input interface (130), which may be linked to a speaker (132), a display (134) and a remote controller (136), respectively.

The storage part (140) may store the information required for operation of the receiver (100). Various software components may be stored in the receiver (100).

Particularly, operating system (OS) (143), applications (144) and electronic program guide (EPG) (144) may be stored in the storage part (140).

The operating system (143) (for example, LINUX, UNIX, OS X, WINDOWS, Chrome, Symbian, WinCE, Windows Mobile, iOS, Android, Bada, VxWorks, pSOS or other embedded operating systems) may comprise various software components and/or drivers in order to control the system tasks such as memory management, power management, etc.

The application program (144) may be various VOD service programs which are implemented on the operating system (143). The application program (144) may include, for example, any program providing recommendation of movies, announcements, help function. In addition, the application program (144) may include programs which carry out additional services, for example, authentication of subscribers, authentication of adults, box office inquiry or watch history inquiry. Further, the application program (144) may comprise an application program to provide seamless VOD services. For example, the application program (144) may comprise a program which requests the VOD service from a backup contents server when problems have been occurred in the contents server.

The storage part (140) may comprise a volatile memory (141) and a non-volatile memory (142), according to maintaining the memory function without power. In addition, the storage part (140) may comprise at least one storage media selected from a RAM (random access memory), a ROM (read-only memory), an EEPROM (electrically erasable programmable read-only memory), a PROM (programmable read-only memory), a magnetic memory, a magnetic disk, an optical disk, a flash memory, a hard disk, a micro multimedia card, or any card type memory (e.g., an SD card, or an xD memory). Further, the storage part (140) may be a type of a module for using memory functions provided by a network storage or a cloud service linked via the communication part (110).

The control part (180) controls the components of the receiver (100) in order to implement the processes disclosed in the specification. The control part (180) may implement the software components stored in the memory (140). The storage part (180) may control the interface part (130) linked to the video/audio decoder (120) along with the application programs.

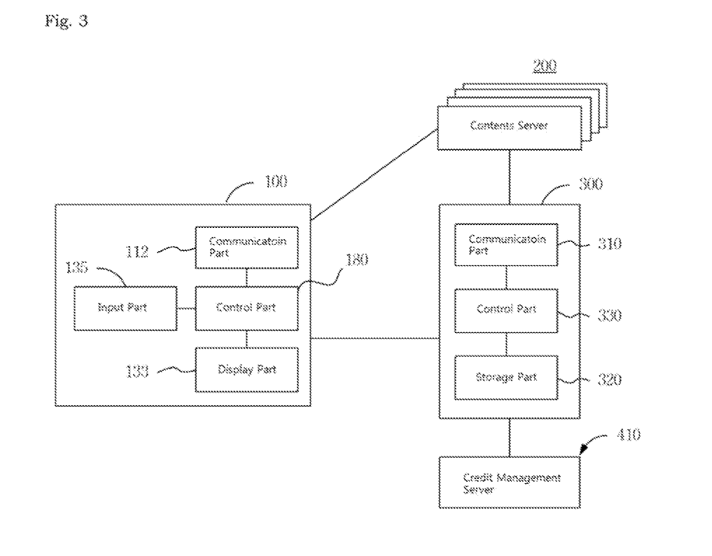

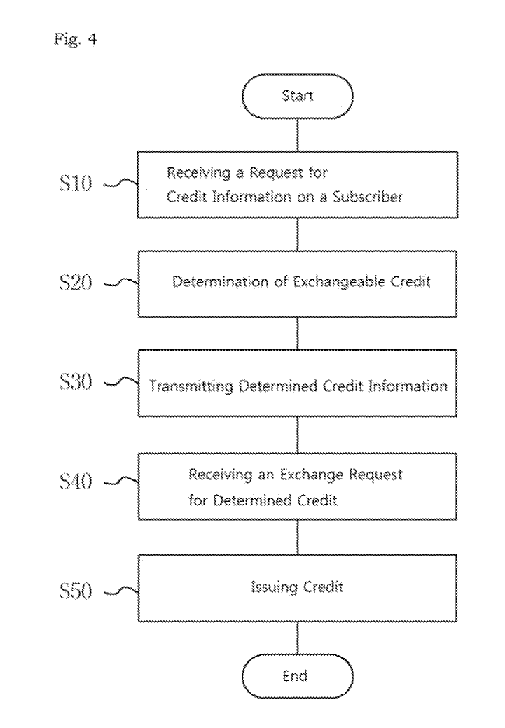

FIG. 3 shows an exemplary VOD system which issues credit based on remaining purchase information.

The VOD system according to the embodiments disclosed in the specification exchanges rights remaining without consumption with credit having other value. For this, the management device (300) in the VOD system issues credit, based on the remaining purchase information of the subscriber of the VOD service, according to the exchange request received from the receiver (100).

Detailed Constitution of the Receiver

With reference to FIG. 3, the receiver (100) may comprise a communication part (112), a display part (133), an input part (135) and a control part (180).

The receiver (100) according to the embodiments disclosed in the specification obtains credit, based on the purchase information in the VOD system.

The communication part (112) communicates with the management device (300) via management channels. That is, the communication part (112) receives the exchangeable credit information of the subscriber from the management device (300), and transmits an exchange request to the management device (300).

The display part (133) displays the exchangeable credit information received from the management device (300). The display part (133) may display the kind, name or amount of the credit in order to display the information on the exchangeable credit. The exchangeable credit information may be displayed as text or graphical object.

The input part (135) receives input signals selecting at least a part of the exchangeable credit information. The input part (135) may be a form receiving signals from external input devices such as the remote controller (136), an input module attached to the receiver (100), or an input module linked to the display part (133), such as a touch pad receiving touch signals. The exchange request includes the selection information on the credit selected according to the input signals.

The control part (180) obtains the credit issued for the subscriber, in cooperation with the communication part (112), the display part (133) and the input part (135). The issued credit, in response to the exchange request, is issued based on the remaining purchase information of the subscriber.

Detailed Constitution of the Management Device

Referring to FIG. 3, the management device (300) according to the embodiment disclosed in the specification may comprise a communication part (310), a storage part (320) and a control part (330).

The communication part (310) communicates with the receiver (100) via the management channel. In detail, the communication part (310) receives a request for credit information from the receiver (100). In addition, the communication part (310) transmits the exchangeable credit information of the subscriber to the receiver (100). Further, the communication part (310) receives an exchange request including the selection information on at least a part of the exchangeable credit.

The storage part (320) stores the information on the subscribers and the available credit.

The information on the subscribers includes personal information of the subscriber who paid for VOD services. The information on the subscriber may be, for example, a telephone number, an e-mail address, a terminal, user ID or any information for identification of the subscriber. In addition, the information on the subscriber comprises the information on the receiver (100) which communicates with the management device (300) in order to access to the VOD services. The information on the subscriber may be, for example, the device identification number of the receiver (100) or the identification number of the smart card attached to the receiver (100). Further, the information on the subscriber includes the subscriber's usage history of the VOD services. The information on the subscriber includes, for example, a purchase information, a remaining purchase information or a contents consumption history of the subscriber.

The information on the subscriber stored in the storage part (320) may be used for authentication or identification of the subscriber. In embodiments disclosed in the specification, the information on the subscriber to be used for identification of the subscriber includes a user ID, a telephone number, a receiver identification number, a resident registration number, a social security number, an account number, a personal identification number (PIN), or a medium access control (MAC) address of a receiver.

The information on the subscriber may be stored in the storage part (320) in a form of a customer information database. In addition, the management device (300) may receive the information on the subscriber from the right management server (500) and, if necessary, receive the information on the subscriber by requesting the right management server (500), periodically or at any predetermined time.

For example, the communication part (310) may communicate with the right management server which provides the purchase information of the subscriber, and the storage part (320) may store the subscriber's remaining purchase information received from the right management server. When these remaining purchase information is exchanged with credit according to embodiments disclosed in the specification, the communication part (310) may request the right management server to decrease the remaining purchase information by an amount corresponding to the selection information.

The available credit information may be that received from the credit issuer of the storage part (320). For this, the communication part (310) may communicate with the credit issuer.

The control part (330) issues credit for the subscriber, in cooperation with the communication part (310) and the storage part (320).

The control part (330) determines the exchangeable credit in response to the request for credit information received from the receiver (100), and transmits the exchangeable credit to the receiver (100) through the communication part (310). That is, the control part (330) determines the exchangeable credit from the available credit, based on the remaining purchase information of the subscriber of the receiver (100).

In addition, the control part (330) issues credit corresponding to the selected information included in the exchange request received from the receiver (100), for the subscriber. In detail, the control part (330) allocates the credit corresponding to the selected information, and decreases the remaining purchase information by an amount of the selected information, thereby issuing credit.

The control part (330) may control the communication part (310) so as to transmit the credit information issued for the subscriber to the credit issuer.

The control part (330) may control the constitutional components so as to notify the subscriber or the receiver (100) of the information on the issued credit. In detail, the control part (330) may control the communication part (310) so as to notify the terminal of the information on the issued credit. In addition, the management device (300) may further comprise a notification part which notifies the subscriber of the information on the issued credit. Further, the control part (330) may control the notification part so as to transmit the information on the issued credit to a mobile terminal, an e-mail address or a personal data storage of the subscriber.

Procedure for Issuing Credit

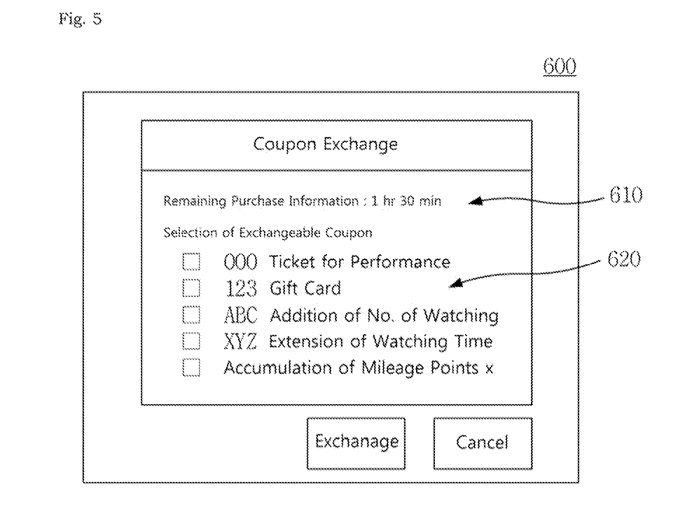

FIG. 4 illustrates an exemplary method for issuing credit based on purchase information.

The management device (300) receives a request for credit information from the receiver (100) (S10). The receiver (100) transmits the request for credit information to the management device (300) through the management channel. The request for credit information is for requesting to transmit the information on the exchangeable credit, based on the remaining purchase information of the subscriber who is a user of the receiver (100).

The management device (300) determines the exchangeable credit that can be exchanged with the remaining purchase information of the subscriber, in response to the request for credit information received from the receiver (100) (S20). For this, the management device (300) may receive and store the available credit list for all the subscribers of the VOD service. In addition, the management device (300) may identify the subscriber through the authentication procedure in cooperation with the receiver (100), and check the remaining purchase information of the identified subscriber. The management device (300) may determine the exchangeable credit form the available credit, for the sake of the subscriber.

The management device (300) transmits the exchangeable credit information to the receiver (100) (S30), and the receiver (100) displays the available credit information. The management device (300) can also transmit the remaining purchase information of the subscriber, and the receiver (100) can display the remaining purchase information. FIG. 5 is an example of the screen (600) that displays the exchangeable credit information (620) and the remaining purchase information (610) displayed by the receiver (100).

The receiver (100) selects at least a part of the exchangeable credit by the input part of the remote controller of the subscriber, and transmits the selection information to the management device (300) (S40). The management device (300) issues credit for the subscriber, based on the selection information on the credit received from the receiver (100) (S50). The management device (300) may update the storage part (320) so that the credit corresponding to the selection information may be allocated to the subscriber and the remaining purchase information of the subscriber may be decreased by an amount of the selection information.

Example of Detailed Procedure for Issuing Credit

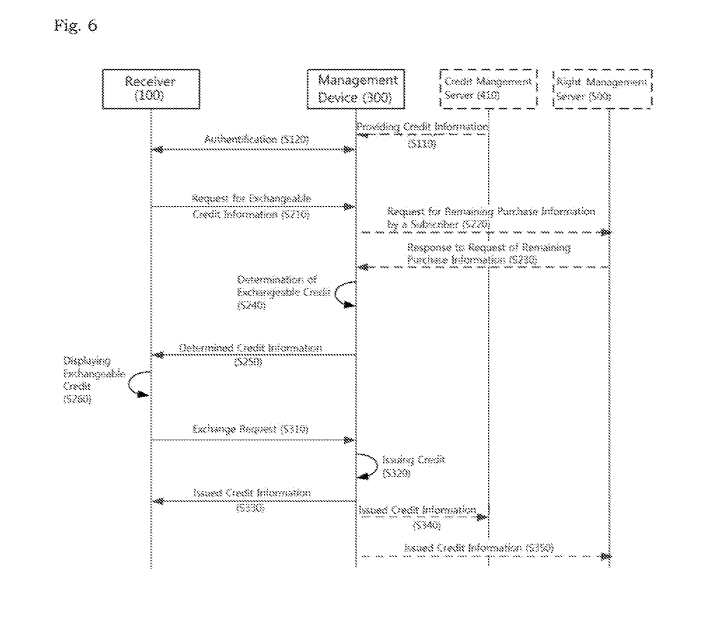

FIG. 6 is a flow chart that describes in detail the issuing procedure of credit shown in FIG. 4.

Before starting the procedure for issuance of credit, the receiver (100) and the management device (300) may perform the procedure for authentication (S110). The authentication procedure may be carried out in order to receive the VOD service after the receiver (100) is turned on. As a result of the authentication procedure, the management device (300) may have the information to identify the terminal or the subscriber using the VOD service.

In addition, the credit management server (410) may provide the management device (300) with the credit information (S120). The credit information may be transmitted in a predetermined time and method between the management device (300) and the credit management server (410). However, the step S120 may be carried out only after requesting for the credit information by the receiver (100). The credit information provided by the credit management server (410) may be information on the additional services in the VOD service, which can be provided by the management device (300).

First, the receiver (100) transmits the message to request for the exchangeable credit information to the management device (300) (S210). The request for credit information may be performed by an application program that implements the exchange function carried out on the receiver (100).

Next, the management device (300) transmits the subscriber's request for the remaining purchase information to the right management server (500) (S220). The subscriber's request for the remaining purchase information may include the identification information on the subscriber who is known by the authentication procedure carried out in the previous step.

The right management server (500) transmits, in response to the request for the remaining purchase information, the subscriber's remaining purchase information to the management device (300) (S230).

The information on the subscriber may be stored in the storage part (320) in a form of a customer information database. In addition, the management device (300) may receive the information on the subscriber from the right management server (500) and, if necessary, receive the information on the subscriber by requesting the right management server (500), periodically or at any predetermined time.

Then, the management device (300) determines the exchangeable credit from the subscriber's remaining purchase information, in response to the request (S210) for the credit information received from the receiver (100) (S240). The management device (300) can determine the exchangeable credit for the subscriber from the available credit, as received by the above-mentioned step S120.

Next, the management device (300) transmits the exchangeable credit information to the receiver (100) (S250), and the receiver (100) displays the exchangeable credit information (S260). The receiver (100) may also display the remaining purchase information.

Subsequently, the receiver (100) transmits the message of exchange request including at least a part of the selection information from the exchangeable credit, to the management device (300) (S310). Then, the management device (300) issues credit for the subscriber, based on the selection information included in the message of exchange request received from the receiver (100) (S320).

Next, the management device (300) may transmit, in response to the message of exchange request, the issued credit information to the receiver (100) (S330).

Then, the management device (300) may update the storage part (320) so that the credit corresponding to the selection information may be allocated to the subscriber and the remaining purchase information of the subscriber may be decreased by an amount of the selection information. The issued credit information is transmitted to the credit management server (410) so that the issued credit information can be updated (S340). In addition, the management device (300) may transmit the issued credit information to the right management server (500) so that the issued credit information may be updated (S350).

### Modified Example

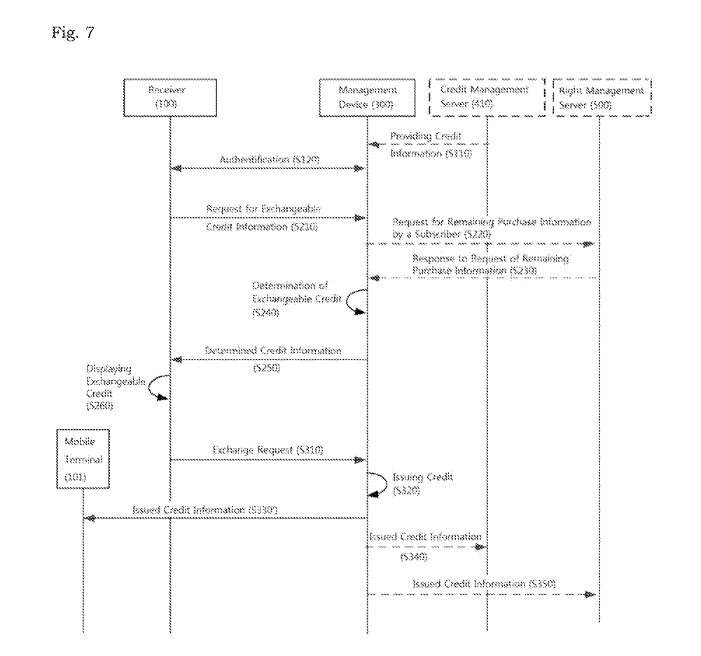

FIG. 7 is a flow chart illustrating an embodiment of notifying the information of the issued credit to a subscriber. The description for the steps in FIG. 7 which are the same as those shown in FIG. 6 will be omitted.

Comparing the example of FIG. 6, the management device (300) notifies the issued credit information of the subscriber through the step (S320) of issuing credit (S330). In detail, the management device (300) notifies the issued credit information to the subscriber through SMS (short message service) or MMS (multimedia messaging service) of the subscriber's mobile terminal, an e-mail, or a personal data storage.

### Simple Example

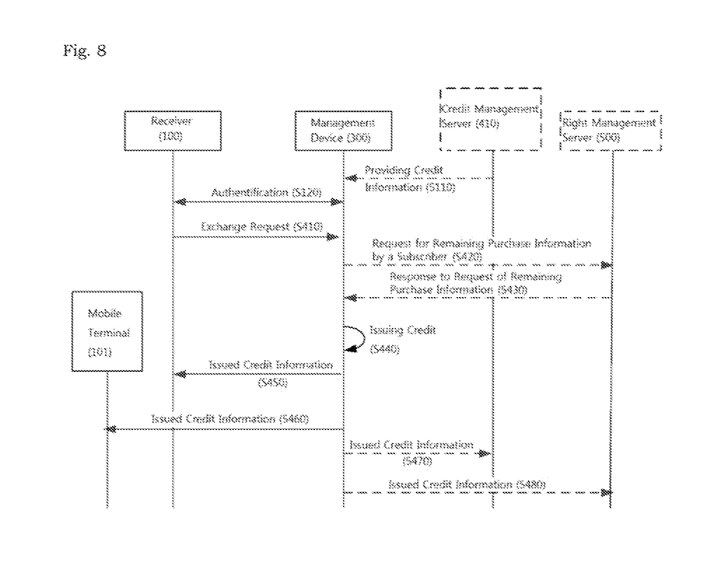

The procedure for issuing credit based on the remaining purchase information as mentioned above, may be carried out simply as shown in FIG. 8. FIG. 8 is a flow chart illustrating the procedure of exchanging all of the remaining purchase information with credit.

FIG. 8. illustrates exemplary embodiments that can be applicable to exchange a certain amount of the remaining purchase information during VOD service, exchange all the remaining purchase information regardless of an amount of the remaining purchase information, exchange the remaining purchase information in case of knowing the information on the specific credit to be exchanged, etc. The description for the steps in FIG. 8 which are the same as those shown in FIG. 6 will be omitted.

First, the receiver (100) transmits the message to request for exchanging the remaining purchase information with the credit, to the management device (S410). The message to request for exchange may include a certain amount of the remaining purchase information or the certain credit to be exchanged and, for this, the receiver (100) may receive the information on the subscriber's remaining purchase information or the exchangeable credit at the previous step. In addition, when the message to request for exchange does not contain other information, the management device (300) can allocate all the remaining purchase information for exchange, or allocate the remaining purchase information as small as not to be used in the VOD service.

Next, the management device (300), if required, requests the right management server (500) to provide the subscriber's remaining purchase information, and the right management server (500) may transmit the subscriber's remaining purchase information to the management device (300) in response to the request for the remaining purchase information (S420).

Subsequently, the management device (300) issued credit for the subscriber, based on the information of the object to be exchanged, which is included in the message to request for exchange received from the receiver (100) (S440).

Then, the description for the steps for treating the issued credit (S450, S460, S470 and S480) which are identical to the steps, S330, S330′, S340 and S350, respectively, will be omitted.

The scope of the present invention is not limited by the embodiments disclosed in the specification, and the present invention may be modified, altered and improved variously within the scope of the gist of the invention and the following claims.

1. A method for issuing credit to a subscriber by a management device in an on-demand video system, the method comprising:
receiving a request for credit information on a subscriber from a receiver;
determining exchangeable credit based on the remaining purchase information on said subscriber in response to said request for credit information;
transmitting information on said determined credit to said receiver;
receiving an exchange request including selective information on at least a part of said determined credit from said receiver; and
issuing credit corresponding to said selective information, to said subscriber.

2. The method of claim 1, wherein said credit is information on time of watching said on-demand video, number of watching said on-demand video, mileage, point or coupon.

3. The method of claim 1, wherein said issuing comprises:
allocating said credit corresponding to the selective information to said subscriber; and
decreasing said remaining purchase information according to an amount of said selective information.

4. The method of claim 3, further comprising receiving available credit information from a credit issuer, wherein said exchangeable credit is determined from said available credit.

5. The method of claim 4, further comprising transmitting said allocated credit information to said subscriber.

6. The method of claim 3, wherein said remaining purchase information of said subscriber is obtained from a right management server, based on an identification information of said subscriber.

7. The method of claim 6, further comprising requesting to said right management server for decreasing said remaining purchase information of said subscriber, based on an amount of said selective information.

8. The method of claim 3, further comprising notifying said receiver of said issued credit.

9. The method of claim 3, further comprising notifying said subscriber of said issued credit.

10. The method of claim 9, wherein said issued credit is notified to said subscriber by transmitting information on said issued credit to a mobile terminal, an e-mail address or an individual data storage of said subscriber.

11. The method of claim 1, wherein said subscriber is identified by subscriber identification information including at least one information selected from the group consisting of a user ID, a telephone number, a receiver identification number, a resident registration number, a social security number, an account number, a personal identification number (PIN), and a medium access control (MAC) address of a receiver.

12. A device for issuing credit in an on-demand video system, the device comprising:
a storage part which stores a remaining purchase information and an available credit of a subscriber;
a communication part which communicates with a receiver through a management channel; and
a control part which issues credit for said subscriber in cooperation with said storage part and said communication part,
wherein said communication part receives a request for credit information from said receiver, transmits information on exchangeable credit information to said receiver, and receives an exchange request including selective information on at least a part of said exchangeable credit, and
wherein said control part determines said exchangeable credit based on the remaining purchase information on said subscriber in response to said request for credit information, and issues credit corresponding to said selective information, to said subscriber.

13. The device of claim 12, wherein said credit is information on time of watching said on-demand video, number of watching said on-demand video, mileage, point or coupon.

14. The device of claim 12, wherein said communication part communicates with a credit issuer which provides said credit information, and wherein said storage part stores said available credit received from said credit issuer.

15. The device of claim 14, wherein said communication part transmits said credit information issued for said subscriber to said credit issuer.

16. The device of claim 12, wherein said control part allocates said credit corresponding to the selective information to said subscriber, and decreases information out of said remaining purchase information, to an extent that corresponds to an amount of said selective information.

17. The device of claim 16, wherein said communication part communicates with said right management server which provides purchase information of said subscriber, and wherein said storage part stores said remaining purchase information of said subscriber, received from said right management server.

18. The device of claim 17, wherein said communication part requests said right management server to decrease information out of said remaining purchase information, to an extent that corresponds to an amount of said selective information.

19. The device of claim 16, further comprising a notification part which notifies said subscriber of information on said issued credit, said notification part transmitting information on said issued credit to a mobile terminal, an e-mail address or an individual data storage of said subscriber.

20. The device of claim 16, wherein said communication part notifies said terminal of information on said issued credit.

21. A method for obtaining credit in an on-demand video system based on a remaining purchase information, the method comprising:
transmitting a request for credit information of a subscriber to a management device;
receiving a exchangeable credit information of said subscriber;
displaying said exchangeable credit information on a display part;
receiving input signals to select at least a part from said exchangeable credit information;
transmitting an exchange request including said information selected by said input signals; and
receiving the issued credit information based on said remaining purchase information in response to said exchange request.

22. A device for receiving video which provides credit in an on-demand video system, the device comprising:
a communication part which receives a exchangeable credit information of a subscriber from a management device and transmits an exchange request to said management device;
a display part which displays said exchangeable credit information;
an input part which inputs input signals selecting at least a part of said exchangeable credit information;
a control part which obtains issued credit for said subscriber in cooperation with said communication part, said display part and said input part,
wherein said exchange request includes selective credit information according to said input signals, and
wherein said issued credit is issued in response to said exchange request, based on remaining purchase information of said subscriber.
